(19) United States
(12) Patent Application Publication
(10) Pub. No.: US 2026/0275006 A1
(43) Pub. Date: Sep. 17, 2026

(54) PROCESS FOR PRODUCING BRANCHED POLYOLEFIN

(71) Applicant: Dow Global Technologies LLC, Midland, MI (US)

(72) Inventors: Lixin Sun, Sugarland, TX (US); Thomas Wesley Karjala, JR., Lake Jackson, TX (US); Edmund M. Carnahan, Pearland, TX (US)

(21) Appl. No.: 19/167,194

(22) PCT Filed: Feb. 28, 2024
(86) PCT No.: PCT/US2024/017664

§ 371 Date: Sep. 19, 2025

Related U.S. Application Data
(60) Provisional application No. 63/492,584, filed on Mar. 28, 2023.

(51) Int. Cl. C08F 10/02; C08F 2/38; C08F 4/64

(52) U.S. Cl. CPC C08F 10/02; C08F 2/38; C08F 4/64193; C08F 2410/01; C08F 2500/12; C08F 2500/29

(57) ABSTRACT

The present disclosure provides a process. In an embodiment, that process includes contacting, under polymerization conditions at a temperature from 160° C. to 250° C., a single polymerization catalyst and a cocatalyst in a single reactor with (i) an ethylene monomer and an optional C₃-C₈ α-olefin in comonomer, (ii) an alkyl-aluminum chain transfer agent, and (iii) an alkyl-zinc chain transfer agent. The process includes forming an ethylene-based polymer having an I₁₀/I₂ value greater than 8.0 and a vinyl content CA of greater than 50/1,000,000C.

### BACKGROUND

An olefin-based polymer with long chain branching (LCB) is an olefin-based polymer containing one or more side chain branches whose length is comparable to or longer than a critical entanglement length. Incorporating long chain branching (LCB) is known to enhance the processibility and increase melt strength in olefin-based polymers.

Compared with a linear olefin-based polymer having the same molecular weight, an olefin-based polymer with LCB shows higher shear sensitivity, higher zero shear viscosity, greater melt elasticity, greater impact strength, and higher melt strength (“melt strength” being the resistance to stretching during elongation of the molten olefin-based polymer). High melt strength is a desirable mechanical property in thermoforming, extrusion coating, and blow molding processes involving olefin-based polymers.

In addition, olefin-based polymer with LCB exhibits higher viscosity at low shear rate and lower viscosity at high shear rate when compared to linear olefin-based polymer having the same molecular weight. Shear thinning is advantageous in polymer processing, such as under high shear conditions.

For linear low density polyethylene (LLDPE), a common mechanism to form LCB during coordination polymerization (a form of addition polymerization mediated by transition metal catalysts) of olefin is through the insertion of vinyl-terminated polymer chains generated by thermal termination at transition metal catalyst sites. The level of LCB formed by this mechanism is typically low due to the low population of vinyl terminated polymer chains. In contrast, low density polyethylenes (LDPEs) produced by free radical polymerization are known for superior processibility due to the unique “tree-like” branch-on-branch structures. Known is the addition of α, ω-dienes, such as decadiene, during olefin polymerization to bridge two polymer chains. The α, ω-diene approach is disadvantageous because it increases the risk of gelling in the reactor system and imparts logistical burdens due to the limited availability and high cost of industrial-scale quantities of α, ω-diene.

The art recognizes the need for alternative processes to produce long chain branching in olefin-based polymer. In particular a need exists for a process to produce long chain branching in olefin-based polymer(and ethylene-based polymer in particular) by way of coordination polymerization of olefins.

### SUMMARY

The present disclosure provides a process. In an embodiment, the process includes contacting, under polymerization conditions at a temperature from 160° C. to 250° C., a single polymerization catalyst and a cocatalyst in a single reactor with (i) an ethylene monomer and an optional C₃-C₈ α-olefin comonomer, (ii) an alkyl-aluminum chain transfer agent, and (iii) an alkyl-zinc chain transfer agent. The process includes forming an ethylene-based polymer having an I₁₀/I₂ value greater than 8.0 and a vinyl content of greater than 50/1,000,000C.

### BRIEF DESCRIPTION OF THE DRAWINGS

FIG. 1 is a chart showing the chemical structures for different types of carbon-carbon double bonds (unsaturation in polymer chain) for vinylene, trisubstituted, vinyl, and vinylidene.

FIG. 2 is a schematic representation of a polymerization process in accordance with an embodiment of the present disclosure.

FIG. 3 is a graph showing GPC curves and a Mark-Houwink plot for comparative sample 1 and inventive example 1.

FIG. 4 is a graph showing GPC curves and g′ values for comparative sample 1 and inventive example 1.

FIG. 5 is a graph showing a DMS viscosity overlay for comparative sample 6 and inventive examples 6-13.

FIG. 6 is a graph showing a DMS tan delta overlay for comparative sample 6 and inventive examples 6-13.

### DEFINITIONS

Any reference to the Periodic Table of Elements is that as published by CRC Press, Inc., 1990-1991. Reference to a group of elements in this table is by the new notation for numbering groups.

For purposes of United States patent practice, the contents of any referenced patent, patent application or publication are incorporated by reference in their entirety (or its equivalent U.S. version is so incorporated by reference) especially with respect to the disclosure of definitions (to the extent not inconsistent with any definitions specifically provided in this disclosure) and general knowledge in the art.

The numerical ranges disclosed herein include all values from, and including, the lower and upper value. For ranges containing explicit values (e.g., 1 or 2, or 3 to 5, or 6, or 7), any subrange between any two explicit values is included (e.g., the range 1-7 above includes the subranges of from 1 to 2; from 2 to 6; from 5 to 7; from 3 to 7; from 5 to 6; etc.).

Unless stated to the contrary, implicit from the context, all parts and percents are based on weight and all test methods are current as of the filing date of this disclosure.

An “alkyl group,” as used herein, is a saturated hydrocarbonyl group.

The terms “blend” or “polymer blend,” as used herein, is a blend of two or more polymers. Such a blend may or may not be miscible (not phase separated at molecular level). Such a blend may or may not be phase separated. Such a blend may or may not contain one or more domain configurations, as determined from transmission electron spectroscopy, light scattering, x-ray scattering, and other methods known in the art.

The term “composition” refers to a mixture of materials which comprise the composition, as well as reaction products and decomposition products formed from the materials of the composition.

The terms “comprising,” “including,” “having” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

An “ethylene-based polymer” and like terms refer to a polymer containing, in polymerized form, a majority weight percent of units derived from ethylene based on the total weight of the polymer. Nonlimiting examples of ethylene-based polymers include low density polyethylene (or “LDPE” that is ethylene homopolymer, or ethylene/α-olefin copolymer comprising at least one C₃-C₁₀ α-olefin, preferably C₃-C₄ (and optional polar termonomer) that has a density from 0.915 g/cc to 0.940 g/cc and contains long chain branching with broad MWD, typically produced by way of high pressure free radical polymerization), linear low density polyethylene (or “LLDPE”) a linear ethylene/α-olefin copolymer containing heterogeneous short-chain branching distribution comprising units derived from ethylene and units derived from at least one C₃-C₁₀ α-olefin comonomer or at least one C₄-C₈ α-olefin comonomer, or at least one C₆-C₈ α-olefin comonomer; LLDPE is characterized by little, if any, long chain branching, in contrast to conventional LDPE; LLDPE has a density from 0.880 g/cc, or 0.890 g/cc, or 0.900 g/cc, or 0.910 g/cc, or 0.915 g/cc, or 0.920 g/cc, or 0.925 g/cc to 0.930 g/cc, or 0.935 g/cc, or 0.940 g/cc), very low density polyethylene (VLDPE), ultra low density polyethylene (ULDPE), medium density polyethylene (or “MDPE”-ethylene homopolymer, or an ethylene/α-olefin copolymer comprising at least one C₃-C₁₀ α-olefin, or a C₃-C₄α-olefin, that has a density from 0.926 g/cc to 0.940 g/cc), high density polyethylene (or “HDPE”) is an ethylene homopolymer or an ethylene/α-olefin copolymer with at least one C₄-C₁₀ α-olefin comonomer, or C₄-C₈ α-olefin comonomer and a density from greater than 0.94 g/cc, or 0.945 g/cc, or 0.95 g/cc, or 0.955 g/cc to 0.96 g/cc, or 0.97 g/cc, or 0.98 g/cc).

A “heteroatom” is an atom other than carbon or hydrogen. The heteroatom can be a non-carbon atom from Groups IV, V, VI and VII of the Periodic Table. Nonlimiting examples of heteroatoms include: F, N, O, P, B, S, and Si.

A “hydrocarbon” is a compound containing only hydrogen atoms and carbon atoms. A “hydrocarbonyl” (or “hydrocarbonyl group”) is a hydrocarbon having a valence (typically univalent). A hydrocarbon can have a linear structure, a cyclic structure, or a branched structure

An “interpolymer” is a polymer prepared by the polymerization of at least two different monomers. This generic term includes copolymers, usually employed to refer to polymers prepared from two different monomers, and polymers prepared from more than two different monomers. e.g., terpolymers, tetrapolymers, etc.

The term “long chain branching,” “LCB” and like terms refer to a branch chain extending from the polymer backbone, the branch chain comprising more than one carbon atom. If the polymer is a copolymer (such as ethylene/α-olefin copolymer, for example), then the LCB comprises one carbon more than two carbons less than the total length of the longest comonomer copolymerized with ethylene. For example, in an ethylene/octene copolymer, the LCB is at least seven carbons atoms in length. As a practical matter, the LCB is longer than the side chain resulting from the incorporation of the comonomer into the polymer backbone. The polymer backbone of an HPLDPE comprises coupled ethylene units.

An “olefin-based polymer” or “polyolefin” is a polymer that contains more than 50 weight percent polymerized olefin monomer (based on total amount of polymerizable monomers), and optionally, may contain at least one comonomer. Nonlimiting examples of an olefin-based polymer include ethylene-based polymer or propylene-based polymer.

A “polymer” is a compound prepared by polymerizing monomers, whether of the same or a different type, that in polymerized form provide the multiple and/or repeating “units” or “mer units” that make up a polymer. The generic term polymer thus embraces the term homopolymer, usually employed to refer to polymers prepared from only one type of monomer, and the term copolymer, usually employed to refer to polymers prepared from at least two types of monomers. It also embraces all forms of copolymer, e.g., random, block, etc. The terms “ethylene/α-olefin polymer” and “propylene/α-olefin polymer” are indicative of copolymer as described above prepared from polymerizing ethylene or propylene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to has being based on “units” that are the polymerized form of a corresponding monomer.

### Test Methods

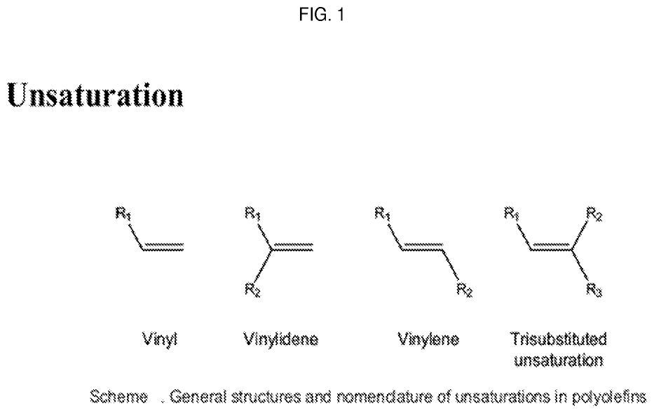

¹H NMR. ¹H nuclear magnetic resonance (¹H NMR) detects the following types of carbon-carbon double bonds (“unsaturation”) in the polymer. “Vinylene” is a carbon-carbon double bond with the formula R₁—CH═CH—R₂, wherein R₁ and R₂ each is a carbon atom, an alkyl group, or a heteroatom selected from N, O, P, B, S, and Si. “Trisubstituted” is a carbon-carbon double bond in which the doubly bonded carbons are bonded to a total of three carbon atoms and wherein R₁, R₂ and R₃ (in FIG. 1) each is a carbon atom. “Vinyl” is a carbon-carbon double bond with the formula R—CH═CH₂, wherein R is a carbon atom or a heteroatom selected from N, O, P, B, S, and Si. “Vinylidene” is a carbon-carbon double bond with the formula C═CH₂. “Total unsaturation (or “total”) is the sum of vinylene, trisubstituted, vinyl, and vinylidene in a polymer. The chemical structures for vinylene, trisubstituted, vinyl, and vinylidene are provided in FIG. 1.

Polymer samples for ¹H NMR analysis were prepared by adding 130 mg of sample to 3.25 g of 50/50 by weight tetrachlorethane-d₂/perchloroethylene with 0.001 M Cr(AcAc)₃ in a 10 mm NMR tube. The samples were purged by bubbling N₂ through the solvent via a pipette inserted into the tube for approximately 5 minutes to prevent oxidation, capped, sealed with Teflon tape. The samples were heated and vortexed at 115° C. to ensure homogeneity.

¹H NMR was performed on a Bruker AVANCE 400/600 MHz spectrometer equipped with a Bruker high-temperature CryoProbe and a sample temperature of 120° C. Two experiments were run to obtain spectra, a control spectrum to quantify the total polymer protons, and a double presaturation experiment, which suppresses the intense polymer backbone peaks and enables high sensitivity spectra for quantitation of the end-groups. The control was run with ZG pulse, 4 scans, SWH 10,000 Hz, AQ 1.64s, D₁ 14s. The double presaturation experiment was run with a modified pulse sequence, Ic1prf2.zz1, TD 32768, 100 scans, DS 4, SWH 10,000 Hz, AQ 1.64s, D₁ 1s, D₁₃ 13s. Results are reported in the number of vinyl groups (and the number of vinylene, trisubstituted, vinylidene, and total) per 1,000,000 carbon atoms, or 1,000,000 C.

Density is measured in accordance with ASTM D792, Method B. The result is recorded in grams per cubic centimeter (g/cc).

Triple Detector GPC (TD-GPC). The chromatographic system for the triple detector gel permeation chromatography (TD-GPC) consisted of a PolymerChar GPC-IR (Valencia, Spain) high temperature GPC chromatograph equipped with an internal IR5 infra-red detector (IR5). The autosampler oven compartment was set at 160° C. and the column compartment was set 150° C. The columns used were 4 Agilent “Mixed A” 30 cm 20-micron linear mixed-bed columns and a 20-um pre-column. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration of the GPC column set was performed with 21 narrow molecular weight distribution polystyrene standards with molecular weights ranging from 580 to 8,400,000 and were arranged in 6 “cocktail” mixtures with at least a decade of separation between individual molecular weights. The standards were purchased from Agilent Technologies. The polystyrene standards were prepared at 0.025 grams in 50 milliliters of solvent for molecular weights equal to or greater than 1,000,000, and 0.05 grams in 50 milliliters of solvent for molecular weights less than 1,000,000. The polystyrene standards were dissolved at 80 degrees Celsius with gentle agitation for 30 minutes. The polystyrene standard peak molecular weights were converted to polyethylene molecular weights using Equation 1 (as described in Williams and Ward, J. Polym. Sci., Polym. Let., 6, 621 (1968)):

$${M}_{polyethylene} = A \times {( {M}_{polystyrene} )}^{B} \qquad ( EQ1 )$$

where M is the molecular weight, A has a value of 0.4315 and B is equal to 1.0

A fifth order polynomial was used to fit the respective polyethylene-equivalent calibration points. A small adjustment to A (from approximately 0.375 to 0.445) was made to correct for column resolution and band-broadening effects such that linear homopolymer polyethylene standard is obtained at 120,000 Mw.

The total plate count of the GPC column set was performed with decane (prepared at 0.04 g in 50 milliliters of TCB and dissolved for 20 minutes with gentle agitation.) The plate count (Equation 2) and symmetry (Equation 3) were measured on a 200 microliter injection according to the following equations:

$$Plate Count = 5.54 * {( \frac{{RV}_{Peak Max}}{Peak Width at \frac{1}{2} height} )}^{2} \qquad ( EQ2 )$$

where RV is the retention volume in milliliters and the peak width is in milliliters, Peak max is the maximum position of the peak, one tenth height is 1/10 height of the peak maximum, and where rear peak refers to the peak tail at later retention volumes than the peak max and where front peak refers to the peak front at earlier retention volumes than the peak max. The plate count for the chromatographic system should be greater than 18,000 and symmetry should be between 0.98 and 1.22.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for 2 hours at 160° Celsius under “low speed” shaking.

The calculations of Mn_{(GPC)}, Mw_{(GPC)}, and MZ_{(GPC)} were based on GPC results using the internal IR5 detector (measurement channel) of the PolymerChar GPC-IR chromatograph according to Equations 4-6, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1.

$${Mn}_{( GPC )} = \frac{{\sum }^{i} {IR}_{i}}{{\sum }^{i} ( {IR}_{i} / {{M}_{polyethylene}}_{i} )} \qquad ( EQ 4 )$$

$${Mn}_{( GPC )} = \frac{{\sum }^{i} {IR}_{i}}{{\sum }^{i} ( {IR}_{i} / {{M}_{polyethylene}}_{i} )} \qquad ( EQ 5 )$$

$${Mz}_{( GPC )} = \frac{{\sum }^{i} ( {IR}_{i} * {{M}_{polyethylene}^{2}}_{i} )}{{\sum }^{i} ( {IR}_{i} / {{M}_{polyethylene}}_{i} )} \qquad ( EQ 6 )$$

In order to monitor the deviations over time, a flowrate marker (decane) was introduced into each sample via a micropump controlled with the PolymerChar GPC-IR system. This flowrate marker (FM) was used to linearly correct the pump flowrate (Flowrate(nominal)) for each sample by RV alignment of the respective decane peak within the sample (RV(FM Sample)) to that of the decane peak within the narrow standards calibration (RV(FM Calibrated)). Any changes in the time of the decane marker peak are then assumed to be related to a linear-shift in flowrate (Flowrate(effective)) for the entire run. To facilitate the highest accuracy of a RV measurement of the flow marker peak, a least-squares fitting routine is used to fit the peak of the flow marker concentration chromatogram to a quadratic equation. The first derivative of the quadratic equation is then used to solve for the true peak position. After calibrating the system based on a flow marker peak, the effective flowrate (with respect to the narrow standards calibration) is calculated as Equation 7. Processing of the flow marker peak was done via the PolymerChar GPCOne™ Software. Acceptable flowrate correction is such that the effective flowrate should be within +/−1% of the nominal flowrate.

$$Flowrate ( effective ) = Flowrate ( nominal ) * \{ RV \{ FM Calibrated ) / RV \{ FM Sample ) ) \qquad ( EQ 7 )$$

Melt flow indices (I₂, I₁₀) were measured according to ASTM Method D1238. I₂ and I₁₀ were measured at 190° C./2.16 kg and 190° C./10 kg respectively. Results are reported in grams eluted per 10 minutes, or g/10 min.

The Dynamic Mechanical Analysis (DMS) was performed using an ARES-G2 rheometer with two parallel plates, having a diameter of 25 mm. The test was performed at 190° C., using a gap of 1.8 mm with a frequency interval ranging from 0.1 to 100 rad/s, at a strain of 10%. By applying this deformation and measuring the resulting torque with the transducer, parameters such as the complex viscosity, storage and loss modulus at a certain shear were determined.

### DETAILED DESCRIPTION

The present disclosure provides a process. In an embodiment, a process is provided and includes contacting, under polymerization conditions at a temperature from 160° C. to 250° C., a single polymerization catalyst and a cocatalyst in a single reactor with (i) an ethylene monomer and an optional C₃-C₈ α-olefin comonomer, (ii) an alkyl-aluminum chain transfer agent, and (iii) an alkyl-zinc chain transfer agent; and forming an ethylene copolymer having an I₁₀/I₂ value greater than 8.0 and a vinyl content of greater than 50/1,000,000C.

The process includes contacting, under polymerization conditions at a temperature from 160° C. to 250° C., a single polymerization catalyst and a cocatalyst with (i) an ethylene monomer and an optional C₃-C₈ α-olefin comonomer, (ii) an alkyl-aluminum chain transfer agent, and (iii) an alkyl-zinc chain transfer agent. The term “polymerization conditions,” as used herein, refers to process parameters under which ethylene (and optional C₃-C₈ α-olefin comonomer) are copolymerized in the presence of a catalyst system. Polymerization conditions include, for example, polymerization reactor conditions (reactor type), reactor pressure, reactor temperature, concentrations of reagents and polymer, solvent, carrier, residence time and distribution, influencing the molecular weight distribution and polymer structure. The term polymerization conditions, as used herein, includes a single (one and only one) polymerization reaction, and a polymerization reactor temperature from 160° C. to 250° C., or from 180° C. to 250° C., or from 182° C. to 240° C., or from 190° C. to 240° C., or from 192° C. to 230° C., or from 200° C. to 220° C.

The single (one and only one) polymerization catalyst has the resilience for ethylene polymerization at high temperature, or a temperature from 160° C. to 250° C., or from 180° C. to 250° C. The single polymerization catalyst exhibits efficient chain transfer with alkyl-zinc, and good ability to incorporate vinyl-termination polymeryl chains. In an embodiment, the polymerization catalyst has the Formula (1)

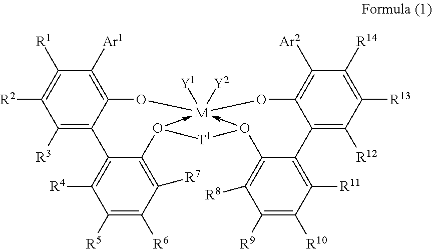

wherein
M is titanium, zirconium, hafnium, or scandium;
each Y¹ and Y² is independently selected from the group consisting of (C₁-C₄₀)hydrocarbyl, (C₁-C₄₀)trihydrocarbylsilylhydrocarbyl, halogen, alkoxide, or amine, or two Y groups together are a divalent hydrocarbylene, hydrocarbadiyl or trihydrocarbylsilyl group;
each Ar¹ and Ar² independently is selected from the group consisting of (C₆-C₄₀)aryl, substituted (C₆-C₄₀)aryl, (C₃-C₄₀)heteroaryl, and substituted (C₃-C₄₀)heteroaryl;
T¹ independently at each occurrence is a divalent bridging group of from 2 to 20 carbon atoms, optionally containing heteroatoms including Si, Ge, O, N, S and P; and
each R¹, R², R³, R⁴, R⁵, R⁶, R⁷, R⁸, R⁹, R¹⁰, R¹¹, R¹², R¹³, and R¹⁴ independently is selected from the group consisting of hydrogen, a halogen, (C₁-C₄₀)hydrocarbyl, substituted (C₁-C₄₀)hydrocarbyl, (C₁-C₄₀)heterohydrocarbyl, substituted (C₁-C₄₀)heterohydrocarbyl, (C₆-C₄₀)aryl, substituted (C₆-C₄₀)aryl, (C₃-C₄₀)heteroaryl, and substituted (C₃-C₄₀)heteroaryl, and nitro (NO₂).

In an embodiment, the single polymerization catalyst has the Formula (2)

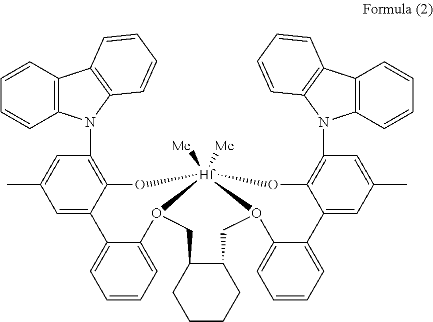

The polymerization conditions include the provision of a cocatalyst. Nonlimiting examples of suitable cocatalyst include boron compounds which may be used as an activating cocatalyst in the preparation of the improved catalysts of this disclosure include the tri-substituted ammonium salts such as trimethylammonium tetrakis(pentafluorophenyl)borate, triethylammonium tetrakis(pentafluorophenyl)borate, tripropylammonium tetrakis(pentafluorophenyl)borate, tri(n-butyl)ammonium tetrakis(pentafluorophenyl)borate, tri(sec-butyl)ammonium tetrakis(pentafluorophenyl)borate, N,N-dimethylanilinium tetrakis(pentafluorophenyl)borate, N,N-dimethylanilinium n-butyltris(pentafluorophenyl)borate, N,N-dimethylanilinium benzyltris(pentafluorophenyl)borate, N,N-dimethylanilinium tetrakis(4-(t-butyldimethylsilyl)-2,3,5,6 tetrafluorophenyl)borate, N,N-dimethylanilinium tetrakis(4-(triisopropylsilyl)-2,3,5,6-tetrafluorophenyl)borate, N,N-dimethylanilinium pentafluorophenoxytris(pentafluorophenyl)borate, N,N-diethylanilinium tetrakis(pentafluorophenyl)borate, N,N-dimethyl-2,4,6-trimethylanilinium tetrakis(pentafluorophenyl)borate, dimethyloctadecylammonium tetrakis(pentafluorophenyl)borate, methyldioctadecylammonium tetrakis(pentafluorophenyl)borate; a number of dialkyl ammonium salts such as: di-(i-propyl)ammonium tetrakis(pentafluorophenyl)borate, methyloctadecylammonium tetrakis(pentafluorophenyl)borate, methyloctadodecylammonium tetrakis(pentafluorophenyl)borate, and dioctadecylammonium tetrakis(pentafluorophenyl)borate; various tri-substituted phosphonium salts such as: triphenylphosphonium tetrakis(pentafluorophenyl)borate, methyldioctadecylphosphonium tetrakis(pentafluorophenyl)borate, and tri(2,6-dimethylphenyl)phosphonium tetrakis(pentafluorophenyl)borate; di-substituted oxonium salts such as: diphenyloxonium tetrakis(pentafluorophenyl)borate, di(o-tolyl)oxonium tetrakis(pentafluorophenyl)borate, and di(octadecyl)oxonium tetrakis(pentafluorophenyl)borate; and di-substituted sulfonium salts such as: di(o-tolyl)sulfonium tetrakis(pentafluorophenyl)borate, and methylcotadecylsulfonium tetrakis(pentafluorophenyl)borate.

An (i) an ethylene monomer and (ii) an optional C₃-C₈ α-olefin comonomer are polymerized under the polymerization conditions. Nonlimiting examples of suitable optional C₃-C₈ α-olefin comonomer include α-olefins having from 3 carbon atoms to 8 carbon atoms, or from 4 carbon atoms to 8 carbon atoms. In an embodiment, the C₃-C₈ α-olefin comonomer is selected from propylene, butene, hexene, and octene. In a further embodiment, the C₄-C₈ α-olefin comonomer is present and the C₄-C₈ α-olefin monomer is selected from butene, hexene, and octene.

In an embodiment, the process includes contacting, under the polymerization conditions at a temperature from 160° C. to 250° C., the single polymerization catalyst and the cocatalyst with only (i) ethylene monomer and (ii) one or more C₄-C₈ olefin comonomers and to the exclusion of diene, and/or to the exclusion of a branching agent.

The process includes contacting, under the polymerization conditions at a temperature from 160° C. to 250° C., the single polymerization catalyst and the cocatalyst with (i) ethylene monomer and an optional C₃-C₈ α-olefin comonomer, (ii) an alkyl-aluminum chain transfer agent, and (iii) an alkyl-zinc chain transfer agent. A “chain transfer agent,” as used herein, refers to a compound that is capable of exchanging an alkyl group or polymeryl group on the chain transfer agent with a growing polymer chain on the catalyst, the exchange resulting in termination of the polymer chain growth under the polymerization conditions. An “alkyl-aluminum chain transfer agent,” as used herein, is a chain transfer agent that is a compound having the formula R¹AlR²R³, wherein R¹, R² and R³ each is independently a C₁-C₂₀, or a C₂-C₁₀, or a C₂-C₄ alkyl group. An “alkyl-zinc chain transfer agent,” as used herein is a chain transfer agent that is a compound having the formula R⁴ZnR⁵ wherein R⁴ and R⁵ each is independently a C₁-C₂₀, or a C₂-C₁₀, or a C₂-C₄ alkyl group. Nonlimiting examples of alkyl aluminum chain transfer agent include trialkylaluminum such as trimethylaluminum, triethylaluminum, tripropylaluminum, tributylaluminum, triisobutylaluminum, trihexylaluminum, triisohexylaluminum, trioctylaluminum, and triisooctylaluminum. Nonlimitng examples of alkyl-zinc chain transfer agent include dialkyl zinc such as dimethylzinc, diethylzinc, dipropylzinc, dibutylzinc, diisobutylzinc, dihexylzinc, diisohexylzinc, dioctylzinc, and diisooctylzinc.

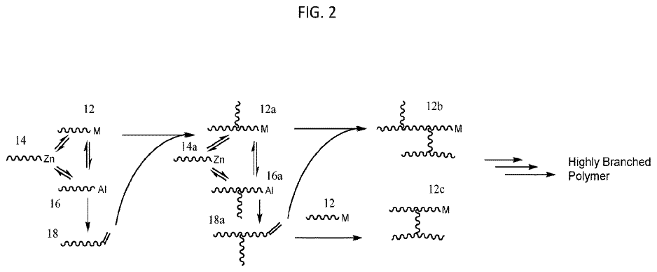

FIG. 2 is a schematic representation of the present process to produce branched polymers. Under the polymerization conditions in a single polymerization reactor at a temperature from 160° C. to 250° C., the contacting of the single polymerization catalyst, cocatalyst, ethylene monomer (and optional C₃-C₈ α-olefin comonomer), alkyl-aluminum chain transfer agent, and the alkyl-zinc chain transfer agent forms, or otherwise polymerizes, the ethylene monomer (and optional C₃-C₈ α-olefin comonomer) into one or more (or a plurality of) growing polymer chains 12. The growing polymer chains 12 on transition metal (M) of the single polymerization catalyst (M being Hf, Zr, Ti, or Sc) undergo chain transfer reaction with the alkyl-zinc chain transfer agent and form one or more zinc-terminated polymer chains 14. The process includes converting the one or more zinc-terminated polymer chains 14 into aluminum-terminated polymer chains 16. The process includes converting the plurality of aluminum-terminated polymer chains 16 through beta-hydride elimination into one or more (or a plurality of) vinyl-terminated-polymeryl chains 18. The vinyl-terminated-polymeryl chains 18 incorporate into the growing polymer chains 12, forming growing branched polymer chains 12a. The growing branched polymer chains 12a repeat the above three steps to transfer to zinc-terminated polymer chains and then again to aluminum to form aluminum-terminated branched polymeryl chains 16a, followed by beta-hydride elimination to form vinyl-terminated branched polymeryl chains 18a, which incorporate into the growing polymeryl chains 12a or 12 to form branch-on-branch polymeryl chains 12b or 12c. In other words, the growing polymer chains 12 first transfer from M to alkyl-zinc to form zinc-terminated polymer chains 14, and then transfer again from zinc-terminated polymer chains to aluminum to form aluminum-terminated polymer chains 16. Bounded by no particular theory, it is believed the catalyst transfer with zinc increases the overall transfer rate to aluminum, with the zinc to aluminum transfer occurring quickly. In this way, the presence of the alkyl-zinc chain transfer agent increases (i.e., shortens) the transfer rate and boosts the chain transfer step compared to the transfer rate with alkyl-aluminum alone.

Polymerization of the growing branched chains and the repeated transfer/elimination/incorporation steps continue and the process forms highly branched ethylene-based polymer having an I₁₀/I₂ value greater than 8.0 and a vinyl content of greater than 50/1,000,000C.

In an embodiment, the process includes contacting, under polymerization conditions at a temperature from 160° C. to 250° C., or from 180° C. to 240° C., with a single polymerization catalyst and a cocatalyst in a single polymerization reactor with
(i) an ethylene monomer,
(ii) an alkyl-aluminum chain transfer agent, or TEA,
(iii) an alkyl-zinc chain transfer agent, or DEZ; and
forming an ethylene homopolymer having an I₁₀/I₂ value greater than 8.0 and a vinyl content greater than 50/1,000,000C.

In an embodiment, the process includes contacting, under polymerization conditions at a temperature from 160° C. to 250° C., or from 180° C. to 240° C., with a single polymerization catalyst and a cocatalyst in a single polymerization reactor with
(i) an ethylene monomer and a propylene comonomer,
(ii) an alkyl-aluminum chain transfer agent, or TEA,
(iii) an alkyl-zinc chain transfer agent, or DEZ; and
forming an ethylene/propylene copolymer having a vinyl content greater than 50/1,000,000C, or from 200/1,000,000C to 3000/1,000,000C, or from 250/1,000,000C to 2500/1,000,000C, or from 275/1,000,000C to 2100/1,000,000C.

In an embodiment, the process includes contacting, under polymerization conditions at a temperature from 160° C. to 250° C., or from 180° C. to 240° C., with a single polymerization catalyst and a cocatalyst in a single polymerization reactor with
(i) an ethylene monomer and octene comonomer,
(ii) an alkyl-aluminum chain transfer agent, or TEA,
(iii) an alkyl-zinc chain transfer agent, or DEZ; and
forming an ethylene/octene copolymer having an I₁₀/I₂ value greater than 8.0, or from 9.0 to 25, or from 10 to 20, or from 12 to 19 and a vinyl content greater than 50/1,000,000C, or from 60/1,000,000C to 300/1,000,000C, or from 70/1,000,000C to 250/1,000,000C, or from 80/1,000,000C to 200/1,000,000C.

The present process enables rapid chain transfer to aluminum (vis-à-vis the alkyl-zinc), followed by beta-hydride elimination of the aluminum-terminated polymer chains to form vinyl-terminated polymeryl chains. Bounded by no particular theory, it is believed the polymerization conditions including the polymerization catalyst and the polymerization temperature from 160° C. to 250° C. promote improved chain transfer ability and efficient beta-hydride elimination enabling significantly high amounts of the vinyl terminated polymeryl chains to be inserted into growing polymer chains for the formation of long chain branches, and also for the generation of branch-on-branch structures.

By way of example, and not limitation, some embodiments of the present disclosure are described in detail in the following examples.

### Examples

Table 1 below provides catalysts, co-catalysts, and chain transfer agents used to prepare Comparative Samples (CS) A-C and Inventive Examples (IE) 1-5.

TABLE 1
Materials

| | |
|---|---|
| Formula (2) (polymerization catalyst) | Hafnium, [rel-2′,2′-[(1R,2R)-1,2- |
| | cyclohexanediylbis(methyleneoxy-.kappa.O)] |
| 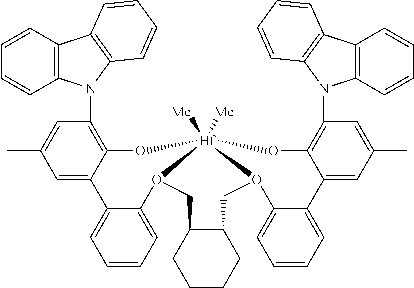 | bis[3-(9H-carbazol-9-yl)-5-methyl [1,1′-biphenyl]-2-olato-.kappa.O]] (2-)]dimethyl-, |
| Formula (3) (polymerization catalyst) | Zirconium, [2′,2′′′-[1,2-cyclohexanediylbis |
| | (methyleneoxy-.kappa.O)]bis[3- |
| 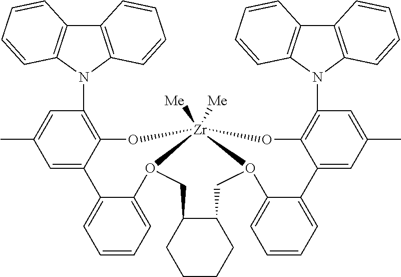 | (9H-carbazol-9-yl)-5-methyl[1,1′- biphenyl]-2-olato-.kappa.O]](2-)]dimethyl- |
| Formula (4) (polymerization catalyst) | Zirconium, dimethyl[[2′,2′′-[1,3- |
| | propanediylbis(oxy-.kappa.O)]bis[3-[3,6- |
| 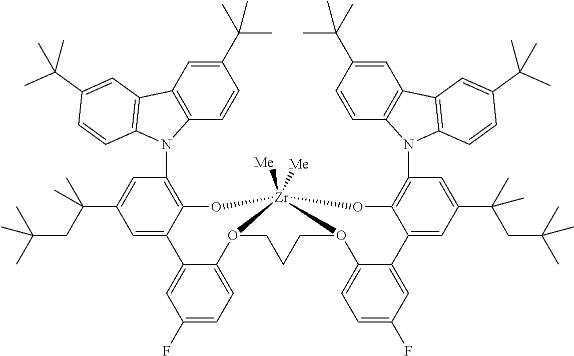 | bis(1,1-dimethylethyl)-9H-carbazol-9- yl]-5′-fluoro-5-(1,1,3,3-tetramethylbutyl) [1,1′-biphenyl]-2-olato-.kappa.O]](2-)]-, |
| Formula (5) (polymerization catalyst) | Hafnium, dimethyl[[2′,2″′-[1,3- |
| | propanediylbis(oxy-.kappa.O) |
| 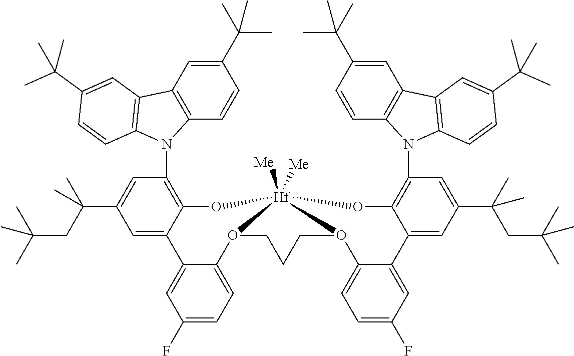 | ]bis[3-[3,6-bis(1,1-dimethylethyl)- 9H-carbazol-9-yl]-5′-fluoro-5-(1,1,3, 3-tetramethylbutyl)[1,1′-biphenyl]- 2-olato-.kappa.O]](2-)]-, |
| Cocatalyst (Borate activator) | Amines, bis(hydrogenated tallow alkyl) |
| R₂MeNH⁺ (R = hydrogenated tallow alkyl) | methyl,tetrakis(pentafluorophenyl)borate(1-) |
| 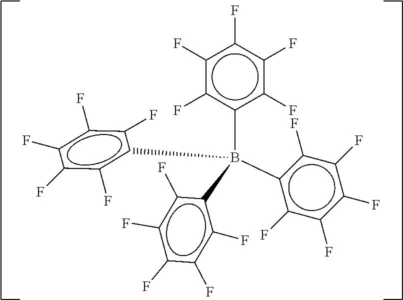 | |
| Cocatalyst (MMAO-3A) | Modified methylalumoxane |
| | (MMAO) Type 3A (no further |
| 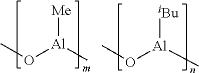 | purification performed) (Akzo Nobel) |
| Alkyl-aluminum chain transfer agent | Triethyl aluminum (TEA) |
| 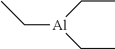 | |
| Alkyl-zinc chain transfer agent | Diethyl zinc (DEZ) |
| 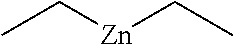 | |

### Inventive Example 1 (IE1)—Ethylene Polymerization in Batch Reactor

A single one gallon stirred autoclave reactor was charged with Isopar™ E mixed alkanes solvent (~1.3 kg). The reactor was heated to 180° C. and charged with triethylaluminum (1 mmol), diethylzinc (0.25 mmol) and ethylene (20 g). The catalyst composition is prepared in a drybox under inert atmosphere by mixing the catalyst of Formula (2) and cocatalyst (mixture of 1.2 equiv borate activator and 10 equiv of modified methyl aluminoxane (MMAO-3A)) with 0.5 ml of toluene and injected into the autoclave reactor to initiate the polymerization. The reactor pressure and temperature was kept constant by feeding ethylene during the polymerization and cooling the reactor as needed. After 10 minutes, the ethylene feed was shut off and the solution transferred into a nitrogen-purged resin kettle. An additive solution containing a phosphorus stabilizer and phenolic antioxidant (Irgafos*168 and Iganox*1010 in a 2:1 ratio by weight in toluene) was added to give a total additive content of approximately 0.1% in the polymer. The polymer is thoroughly dried in a vacuum oven.

### Comparative Sample 1 (CS1)

The same procedure as described in Inventive Example 1 (IE1) was followed except that hydrogen (20 mmole) was charged to replace triethylaluminum and diethylzinc.

The results of inventive example 1 and comparative sample 1 are compared in Table 2.

TABLE 2
Ethylene polymerization

| | | DEZ | TEA | H2 | Yield | | | | | Vinyl |
|---|---|---|---|---|---|---|---|---|---|---|
| | Catalyst | mmol | mmol | mmol | g | Mn | Mw | Mw/Mn | g′ | per million carbon |
| CS1 | Formula (2) | 0 | 0 | 20 | 17 | 80,425 | 253,063 | 3.15 | 1.001 | 35 |
| IE1 | Formula (2) | 0.25 | 1 | 0 | 21 | 25,144 | 52,370 | 2.08 | 0.892 | 390 |

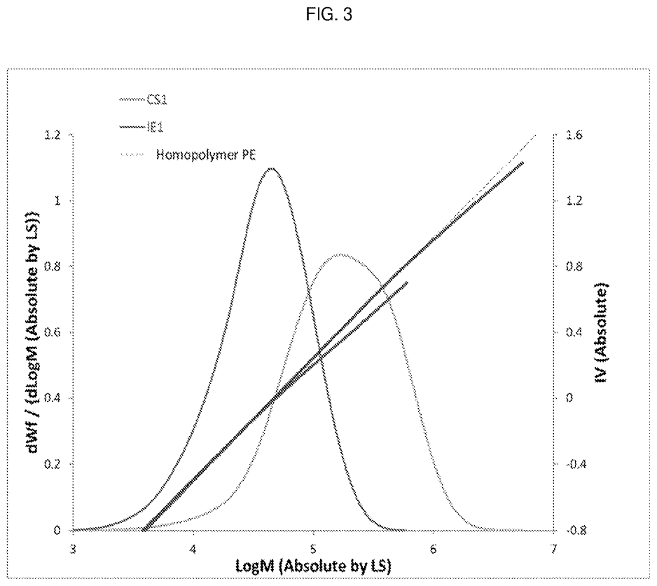

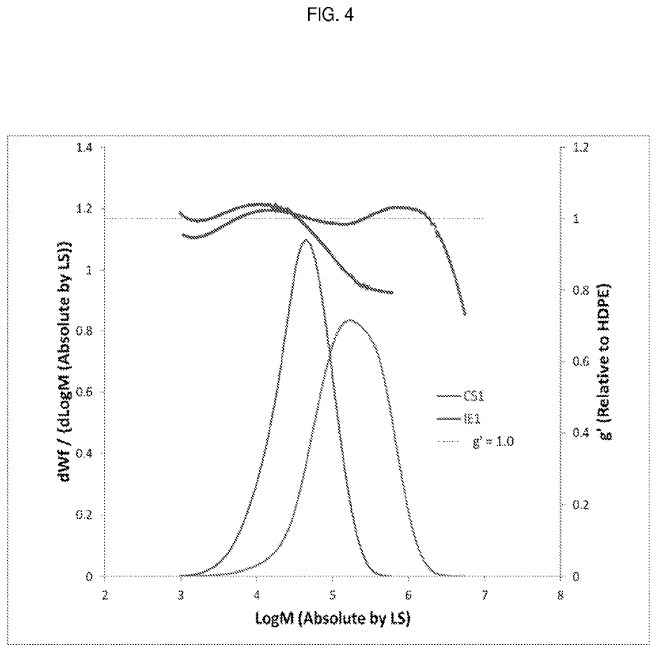

The polymer of inventive example 1 contained a significantly higher amount of terminal vinyl groups as compared to comparative sample 1, demonstrating effective polymer chain transfer to aluminum and the subsequent beta hydride elimination. The vinyl unsaturation formed in the batch reactor shows the amount of vinyl terminated polymer available for insertion and therefore is a good indicator of the ability to form long chain branches. The formation of some long chain branches is evident from GPC Mark-Houwink Plot (FIG. 3) and g′ value (FIG. 4). The Mark-Houwink plot is produced by plotting the molecular weight (MW) against the intrinsic viscosity (IV) on a log-log graph. The presence of long chain branching results in lower intrinsic viscosity (IV) and causes the plot to deviate from that of a linear structure with the same composition. As shown in FIG. 3 the Mark-Houwink plot of the IE1 deviates from the CS1, indicating the presence of higher amount of long chain branches in IE1. The g′ value is also used to characterize the amount of long chain branching in polymer, and is the ratio of determined intrinsic viscosity of the polymer using the calibrated viscometer and concentration detector, and the calculated intrinsic viscosity of an ethylene homopolymer with the same weight average molecular weight. The intrinsic viscosity of the ethylene homopolymer is calculated using the Mark-Houwink Equation, IV=k*Mw^{α}, with a k value of 4.06×10⁴ and an a value of 0.725 (Th. G. Scholte, N. L. J. Meijerink, H. M. Schoffeleers, and A. M. G. Brands, J. Appl. Polym. Sci., 29, 3763-3782 (1984)). As shown in Table 2 and FIG. 4, the IE1 has lower g′ value, which is consistent with the presence of higher amount of long chain branching.

### Inventive Examples 2 to 5—Ethylene-Propylene Copolymerization

To a single one gallon stirred autoclave reactor Isopar™ E mixed alkanes solvent (~1.3 kg) was charged and heated to 180° C. Triethylaluminum (1 mmol), diethylzinc (0.25 mmol), propylene (30 g) (“P” in Table 3) and ethylene (30 g) were added in sequence. Varying catalyst compositions are prepared in a drybox under inert atmosphere by mixing the catalyst of Formula (2), Formula (3), Formula (4), and Formula (5) and cocatalyst (mixture of 1.2 equiv borate activator and 10 equiv of modified methyl aluminoxane (MMAO-3A)) with 0.5 ml of toluene and injected into the reactor to initiate the polymerization. For each polymerization only a single catalyst was used. The reactor pressure and temperature was kept constant by feeding ethylene during the polymerization and cooling the reactor as needed. After 10 minutes, the ethylene feed was shut off and the solution transferred into a nitrogen-purged resin kettle. An additive solution containing a phosphorus stabilizer and phenolic antioxidant (Irgafos*168 and Iganox*1010 in a 2:1 ratio by weight in toluene) was added to give a total additive content of approximately 0.1% in the polymer. The polymer is thoroughly dried in a vacuum oven.

### Comparative Samples 2 to 5

The same polymerization procedure was followed as described in Inventive Examples 2 to 5 except that hydrogen (20 mmole) was charged to replace triethylaluminum and diethylzinc.

The results of inventive examples 2 to 5 and the corresponding comparative samples 2-5 are provided in Table 3 below.

TABLE 3
Ethylene-propylene copolymerization

| | | | | | | | | | | | Unsaturation unit/million-carbons | | | | | |
|---|---|---|---|---|---|---|---|---|---|---|---|---|---|---|---|---|
| | Catalyst | | DEZ | TEA | H2 | Yield | | | | P | vinyl- | | | vinyl- | | Vinyl/ |
| Example | Name | μmol | mmol | mmol | mmol | g | Mn | Mw | Mw/Mn | mol % | ene | trisub | vinyl | idene | total | vinylide |
| CS 2 | Formula (3) | 0.3 | | | 20 | 20 | 36,553 | 106,189 | 2.91 | 11.0 | 9 | 4 | 383 | 103 | 449 | 3.7 |
| IE 2 | Formula (3) | 0.88 | 0.25 | 1 | | 28 | 21,993 | 48,836 | 2.23 | 11.0 | 14 | 39 | 2084 | 175 | 2312 | 12.0 |
| CS 3 | Formula (4) | 0.25 | | | 20 | 40 | 23,920 | 47,000 | 1.96 | 12.4 | 6 | 4 | 385 | 213 | 607 | 1.8 |
| IE 3 | Formula (4) | 0.85 | 0.25 | 1 | | 82 | 26,342 | 49,454 | 1.88 | 10.5 | 13 | 18 | 1236 | 281 | 1548 | 4.4 |
| CS 4 | Formula (5) | 0.25 | | | 20 | 29 | 65,912 | 169,013 | 2.56 | 15.3 | 7 | 3 | 154 | 61 | 226 | 2.5 |
| IE 4 | Formula (5) | 0.75 | 0.25 | 1 | | 32 | 40,885 | 81,940 | 2.00 | 14.5 | 8 | 2 | 294 | 80 | 384 | 3.7 |
| CS 5 | Formula (2) | 0.8 | | | 20 | 19 | 79,799 | 204,006 | 2.56 | 15.0 | 15 | 6 | 140 | 50 | 210 | 2.8 |
| IE 5 | Formula (2) | 1.9 | 0.25 | 1 | | 25 | 29,343 | 57,172 | 1.95 | 16.0 | 13 | 5 | 430 | 118 | 567 | 3.6 |

P—Propylene

In comparative samples 2-5, the terminal unsaturations in the polymer were formed via beta-hydride elimination or chain transfer to monomers at the transition metal center, whereas in inventive examples 2-5, the unsaturation values included the contributions of thermal termination reactions on the catalyst and the beta-hydride elimination on the aluminum metals. Two observations were made: (1) for all catalysts, significantly higher amount of vinyl terminated chains were generated in inventive examples 2-5 as compared to respective comparative samples 2-5, which reflected the effectiveness of chain transfer to aluminum metals and the subsequent beta-hydride elimination; (2) inventive examples 2-5 showed higher vinyl/vinylidene ratio, implying that the chain transfer from catalyst to aluminum occurred when ethylene was the last unit. This demonstrates branch formation since only vinyl groups can insert into growing polymeryl chains.

### Inventive Examples 6-14 and Comparative Sample 6—Ethylene/Octene Copolymer in Continuous Reactor

Polymerization was carried out in a single continuous well mixed reactor using Formula (2) as the single catalyst and the borate activator (shown as “cocat 1” in Table 4) and MMAO listed in Table 1 as the cocatalysts. The process conditions and results are shown in Table 4 and 5 below.

TABLE 4
Polymerization in continuous solution reactor

| | Solvent | Ethylene | Octene | Hydrogen | | | |
|---|---|---|---|---|---|---|---|
| | feed, | feed, | feed, | feed, | Catalyst:Cocat | H2 flow, | |
| Run | kg/hr | kg/hr | kg/hr | SCCM | 1 Molar ratio | SCCM | Al-CTA/MMAO |
| CS6 | 22.12 | 5.30 | 0.67 | 430 | 1.19 | 430 | MMAO-3A |
| IE6 | 22.23 | 5.30 | 0.60 | 549 | 1.20 | 549 | TeAl |
| IE7 | 22.05 | 5.30 | 0.80 | 519 | 1.20 | 519 | TeAl |
| IE8 | 22.09 | 5.30 | 0.80 | 519 | 1.20 | 519 | TeAl |
| IE9 | 22.23 | 5.31 | 0.70 | 499 | 1.20 | 499 | TeAl |
| IE10 | 22.14 | 5.31 | 0.72 | 499 | 1.20 | 499 | TeAl |
| IE11 | 22.43 | 5.30 | 0.70 | 374 | 1.20 | 374 | TeAl |
| IE12 | 21.61 | 1.62 | 0.27 | 117 | 1.03 | 117 | TeAl |
| IE13 | 19.67 | 3.77 | 0.50 | 295 | 1.22 | 295 | TeAl |
| IE14 | 19.48 | 3.85 | 0.50 | 286 | 1.20 | 286 | TeAl |

| | | Al-CTA/MMAO | | | | |
|---|---|---|---|---|---|---|
| | | Solution | | AL:Zn | | |
| | Al-CTA/MMAO | Concentration, | Zn-CTA | Molar | Temperature, | Ethylene- |
| Run | flow, g/h | mmol/kg | Name | Ratio | ° C. | Conversion, % |
| CS6 | 24.91 | 3.0 | None | 0.00 | 190 | 94.93 |
| IE6 | 135.07 | 120.0 | DEZ | 2.99 | 190 | 94.91 |
| IE7 | 134.81 | 120.0 | DEZ | 3.00 | 192 | 94.59 |
| IE8 | 135.13 | 120.0 | DEZ | 3.03 | 190 | 94.79 |
| IE9 | 189.95 | 120.0 | DEZ | 3.00 | 190 | 94.76 |
| IE10 | 232.64 | 120.0 | DEZ | 2.90 | 190 | 94.88 |
| IE11 | 374.20 | 120.0 | DEZ | 2.96 | 190 | 94.84 |
| IE12 | 151.38 | 120.0 | DEZ | 2.84 | 182 | −58.39 |
| IE13 | 196.04 | 120.0 | DEZ | 2.94 | 190 | 80.62 |
| IE14 | 197.04 | 120.0 | DEZ | 2.95 | 190 | 95.86 |

TABLE 5
Polymer Properties

| | Melt Index | | Density | | | | Unsaturation unit 1,000,000 carbon | | | | |
|---|---|---|---|---|---|---|---|---|---|---|---|
| Run | dg/min | I₁₀/I₂ | g/cc | Mn | Mw | Mw/Mn | vinylene | trisubstituted | vinyl | vinylidene | total |
| CS6 | 1.1 | 7.7 | 0.9205 | 38,822 | 88,552 | 2.28 | 4 | 1 | 12 | 1 | 19 |
| IE6 | 0.54 | 15.1 | 0.9127 | 29,774 | 75,514 | 2.54 | 8 | 1 | 89 | 5 | 109 |
| IE7 | 1.13 | 12.3 | 0.9208 | 27,375 | 69,036 | 2.52 | 7 | 1 | 93 | 13 | 115 |
| IE9 | 1.06 | 12.8 | 0.9203 | 26,899 | 68,271 | 2.54 | 6 | 2 | 104 | 8 | 119 |
| IE11 | 0.46 | 16.5 | 0.9196 | 28,871 | 79,486 | 2.75 | 9 | 3 | 180 | 14 | 206 |
| IE12 | 0.3 | 18.3 | 0.92 | 27,087 | 75,302 | 2.78 | 9 | 2 | 179 | 14 | 204 |
| IE13 | 0.33 | 17.6 | 0.9213 | 27,216 | 75,232 | 2.76 | 11 | 1 | 138 | 12 | 162 |
| IE14 | 0.3 | 18.1 | 0.922 | 27,335 | 75,720 | 2.77 | 10 | 1 | 139 | 14 | 165 |

Comparative sample 6 was conducted under conventional conditions using hydrogen as molecular weight regulator, producing linear ethylene/octene copolymer with 110/12 of 7.7. Inventive examples 6-14 were run with addition of triethylaluminum and diethylzinc. Significantly higher I₁₀/I₂ values from 12.3 to 18.1 were observed indicating formation of long chain branches, compared to I₁₀/I₂ of 7.7 for CS6.

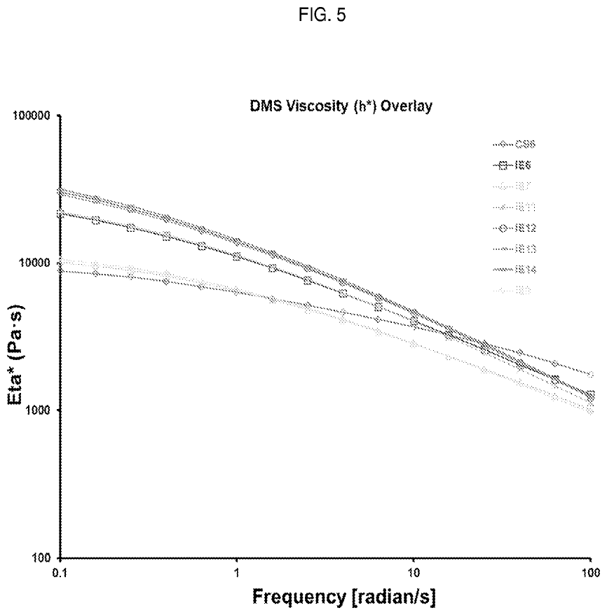

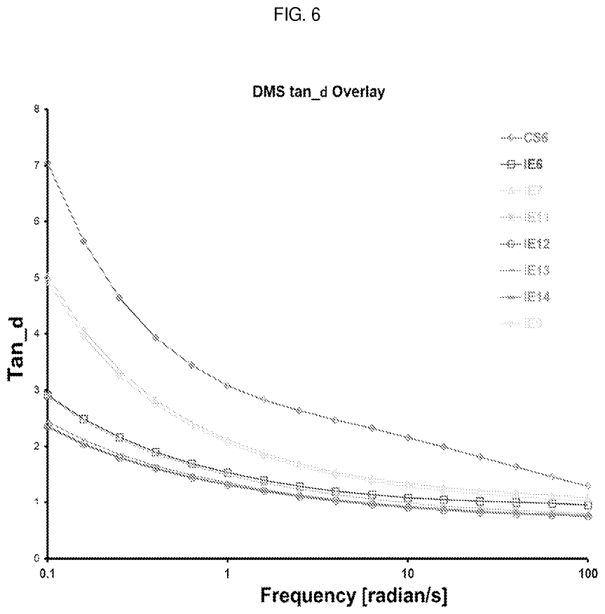

DMS analysis is shown in FIGS. 5-6. The inventive examples 6-14 show significantly different rheological behavior, e. g. higher shear thinning and lower tan-delta values, as compared to the ethylene/octene copolymer produced from the comparative sample 6.

It is specifically intended that the present disclosure not be limited to the embodiments and illustrations contained herein, but include modified forms of those embodiments including portions of the embodiments and combinations of elements of different embodiments as come within the scope of the following claims.

1. A process comprising:
contacting, under polymerization conditions at a temperature from 160° C. to 250° C., a single polymerization catalyst and a cocatalyst in a single reactor with
(i) an ethylene monomer and an optional C₃-C₈ α-olefin comonomer,
(ii) an alkyl-aluminum chain transfer agent, and
(iii) an alkyl-zinc chain transfer agent; and
forming an ethylene-based polymer having an I₁₀/I₂ value greater than 8.0 and a vinyl content of greater than 50/1,000,000C.

2. The process of claim 1 wherein the polymerization catalyst has the Formula (1) 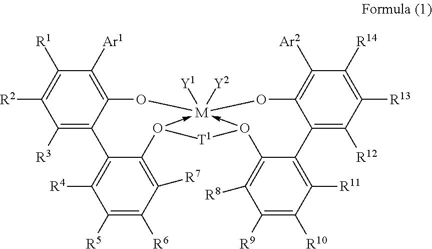
wherein
M is titanium, zirconium, hafnium, or scandium;
each Y¹ and Y² is independently selected from the group consisting of (C₁-C₄₀)hydrocarbyl, (C₁-C₄₀)trihydrocarbylsilylhydrocarbyl, halogen, alkoxide, or amine, or two Y groups together are a divalent hydrocarbylene, hydrocarbadiyl or trihydrocarbylsilyl group;
each Ar¹ and Ar² independently is selected from the group consisting of (C₆-C₄₀)aryl, substituted (C₆-C₄₀)aryl, (C₃-C₄₀)heteroaryl, and substituted (C₃-C₄₀)heteroaryl;
T¹ independently at each occurrence is a divalent bridging group of from 2 to 20 carbon atoms, optionally containing heteroatoms including Si, Ge, O, N, S and P; and
each R¹, R², R³, R⁴, R⁶, R⁶, R⁷, R⁸, R⁹, R¹⁰, R¹¹, R¹², R¹³, and R¹⁴ independently is selected from the group consisting of hydrogen, a halogen, (C₁-C₄₀)hydrocarbyl, substituted (C₁-C₄₀)hydrocarbyl, (C₁-C₄₀)heterohydrocarbyl, substituted (C₁-C₄₀)heterohydrocarbyl, (C₆-C₄₀)aryl, substituted (C₆-C₄₀)aryl, (C₃-C₄₀)heteroaryl, and substituted (C₃-C₄₀)heteroaryl, and nitro (NO₂).

3. The process of claim 1 wherein the polymerization catalyst has the Formula (2)

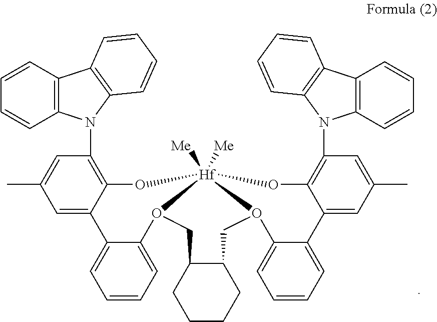

4. The process of claim 1 comprising:
contacting, under polymerization conditions at a temperature from 180° C. to 250° C., the polymerization catalyst of Formula (2) 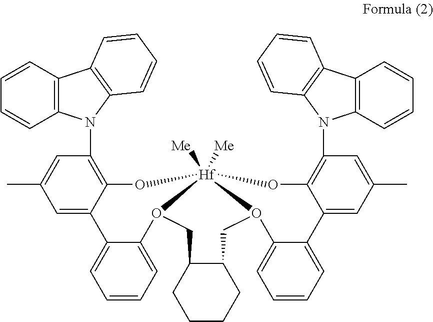
and a cocatalyst with
(i) an ethylene monomer and a C₃-C₈ α-olefin comonomer,
(ii) an alkyl-aluminum chain transfer agent, and
(iii) an alkyl-zinc chain transfer agent;
forming an ethylene copolymer an I₁₀/I₂ value greater than 8.0 and a vinyl content of greater than 50/1,000,000C.

5. The process of claim 1 comprising:
contacting, under polymerization conditions at a temperature from 180° C. to 250° C., a polymerization catalyst of Formula (2) 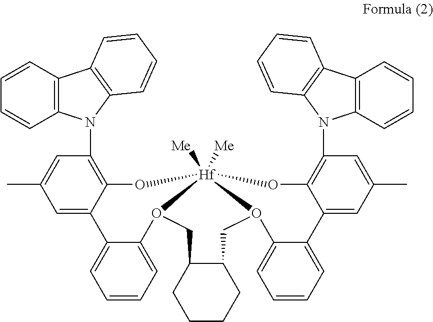
and a cocatalyst with
(i) ethylene monomer and an olefin comonomer selected from the group consisting of propylene, 1-butene, 1-hexene, 1-octene, and combinations thereof;
(ii) a triethylaluminium chain transfer agent; and
(iii) a diethyl zinc chain transfer agent; and
forming an ethylene/C₃-C₈ α-olefin copolymer having an I₁₀/I₂ value greater than 8.0 and a vinyl content of greater than 50/1,000,000C.
